(19) United States
(12) Patent Application Publication
(10) Pub. No.: US 2020/0206912 A1
(43) Pub. Date: Jul. 2, 2020

(54) TRANSMISSION DEVICE AND ROBOTIC ARM

(71) Applicant: INDUSTRIAL TECHNOLOGY RESEARCH INSTITUTE, Hsinchu (TW)

(72) Inventors: Meng-He WU, Hsinchu (TW); Shang-Te CHEN, Hsinchu (TW); Chia-Chung SUNG, Hsinchu (TW); Cheng-Yu CHU, Hsinchu (TW); Jan-Hao CHEN, Hsinchu (TW)

(73) Assignee: INDUSTRIAL TECHNOLOGY RESEARCH INSTITUTE, Hsinchu (TW)

(21) Appl. No.: 16/366,727

(22) Filed: Mar. 27, 2019

(30) Foreign Application Priority Data
Jan. 2, 2019 (TW) 108100007

(51) Int. Cl. B25J 9/10; B25J 19/00

(52) U.S. Cl. CPC B25J 9/106; B25J 17/0283; B25J 19/0025

(57) ABSTRACT

A transmission device is provided, including a first housing, a second housing connected to the first housing, a third housing axially connected to the second housing, an adapter disposed on the third housing, a first power shaft actuating the first housing and the second housing to rotate, a second power shaft actuating the third housing to rotate, and a third power shaft actuating the adapter to rotate. The second and third power shafts are a coaxial structure. The first power shaft is an independent rod. Therefore, a motor loaded with a smaller rotation inertia and being thus cheaper can be used to drive the first power shaft, and the transmission device can have a reduced cost.

### CROSS-REFERENCE TO RELATED APPLICATIONS

This application claims priority to Taiwanese Application Serial No. 108100007, filed on Jan. 2, 2019. The entirety of the above-mentioned patent application is hereby incorporated by reference herein and made a part of this specification.

### BACKGROUND

### 1. Technical Field

This disclosure relates to transmission devices, and, more particularly, to a transmission device applicable to a robotic arm.

### 2. Description of Related Art

Currently, robots are one of the most important equipment for industrial production, and more and more factories use robotic arms in their production lines to do routine or dangerous tasks, such as soldering, trimming, plasma cutting, mold/cast carrying, etc. However, such environments may bring a significant damage to the motors and wires of the robotic arms. Therefore, the motors are generally disposed away from a carrying end.

As shown in FIG. 1A, a six-axis robot 9 according to the prior art is controlled by a control system 9a, and comprises a base 90, a holder 91, a supporting arm 92, a front arm 93, a wrist body 94 and a swing portion 95 constituting a wrist portion, and a rotating disk 96. A motor 9b as a power source of the wrist portion is disposed away from the rotating disk 96. The holder 91 is disposed on the base 90 and rotates about a first rotation axis J1 in an auto-rotation movement manner F1 with respect to the base 90. A bottom end of the supporting arm 92 is rotatably axially connected to the holder 91, and swings back and forth about a second rotation axis J2 in a rotation movement manner F2. The front arm 93 can be rotatably axially connected to a top end of the supporting arm 92, and swings up and down about a third rotation axis J3 in a rotation movement manner F3. The wrist body 94 is disposed on an end portion of the front arm 93, and rotates with the front arm 93 about a fourth axis J4 in an auto-rotation movement manner F4. The swing portion 95 is axially connected to the wrist body 94, and swings up and down about a fifth axis J5 in a rotation movement F5. The rotating disk 96 is used for holding at least one object and disposed on a front end of the swing portion 95, and rotates about a sixth axis J6 in an auto-rotation movement manner F6.

As shown in FIG. 1B, in the six-axis robot 9 according to the prior art in the front arm 93 are disposed with a first transmission rod 81, a second transmission rod 82 and a third transmission rod 83 for driving the auto-rotation movement F4, the rotation movement F5 and the auto-rotation movement F6, respectively. The first transmission rod 81, the second transmission rod 82 and the third transmission rod 83 are mounted therein one another and constitute a three-layer coaxial structure.

However, in the six-axis robot 9 according to the prior art the three-layer coaxial structure is hard to be manufactured. In specific, the innermost layer of the third transmission rod 83 is too thin in the outer radius to be machined easily, and is also not hard enough to support a component connected thereto stably. On the other hand, the outermost layer of first transmission rod 81 is very thick in the outer radius, and has a too great a whole inertia so that the overall supportability of the first transmission rod 81 is insufficient. In the three-layer coaxial structure, since the outermost layer of the first transmission rod 81 has too great the inertia, and the inner layers of the second transmission rod 82 and the third transmission rod 83 are not hard enough to support the components connected thereto, the motor 9b, which provides power, has to absorb the rotation inertia of the first transmission rod 81 and the second transmission rod 82 directly and has to provide more power. Therefore, the motor 9b must be more expensive, and the six-axis robot 9 according to the prior art has a high cost.

In the six-axis robot 9 according to the prior art, the motor 9b is integrated with a speed-reducer, and the speed-reducer is disposed on a top end of the supporting arm 92 adjacent the front arm 93. As such, the speed-reducer has a very small speed-reduction ratio, and the six-axis robot 9 according to the prior art cannot transfer a high torque (the fourth to sixth rotation axes J4, J5 and J6 cannot provide a high torque), or have a high load.

If the fourth rotation axis J4 needs to provide a high torque that is required, the motor 9b needs to provide higher power, and the speed-reducer has to have a bigger volume and a higher speed-reduction ratio. As such, the speed-reducer has to endure a larger torque, and, as a result, the speed-reducer and the motor 9b have their life shortened. Further, too big the front arm 93 is adverse for the six-axis robot 9 to be mounted on a production line.

If both the motor 9b and the speed-reducer are disposed on the wrist body 94 or the swing portion 95, although a high torque can thus be provided, the wrist portion becomes larger and heavier, which causes the wrist portion to be broken easily. The rotating disk 96 cannot hold too heavy an object (or the front arm 93 and the wrist portion will not be stable and the six-axis robot 9 is likely to fall), and the environment when the six-axis robot 9 stays will bring a significant damage to the motor 9b and the wires.

Therefore, how to overcome the drawbacks of the prior art is becoming an urgent issue in the art.

### SUMMARY

In an embodiment, a transmission device according to the present disclosure comprises: a first housing having a first end portion and a second end portion opposing the first end portion; a second housing connected to the first end portion of the first housing; a first speed reducer disposed between the first end portion of the first housing and the second housing; and a first power shaft for actuating the first speed reducer to drive the second housing to rotate.

In an embodiment, the transmission device further comprises a first motor for driving the first power shaft. In another embodiment, the first motor drives the first power shaft through a bevel gear set.

In an embodiment, the first power shaft actuates the first speed reducer through a first transmission mechanism. In another embodiment, the first transmission mechanism is a gear set, and transfers power of the first transmission mechanism through a connection structure to the first speed reducer, and the connection structure is a pipe.

In another embodiment, the transmission device according to the present disclosure comprises: a first housing having a first end portion and a second end portion opposing the first end portion; a second housing connected to the first end portion of the first housing; a third housing axially connected to the second housing; a first speed reducer disposed between the first end portion of the first housing and the second housing; a first power shaft for actuating the first speed reducer through a first transmission mechanism to drive the second housing and the third housing to rotate in the same direction; a second speed reducer disposed on the second housing; and a second power shaft for actuating the second speed reducer through a second transmission mechanism to drive the third housing to rotate with respect to the second housing.

In an embodiment, the transmission device further comprises a first motor disposed on the second end portion of the first housing and drives the first power shaft. In another embodiment, the first motor drives the first power shaft through a bevel gear set.

In an embodiment, the first power shaft actuates the first speed reducer through a first transmission mechanism. For example, the first transmission mechanism is a gear set, and transfers power of the first transmission mechanism through a connection structure to the first speed reducer, and the connection structure is a pipe.

In another embodiment, the transmission device further comprises a second motor for driving the second power shaft.

In yet another embodiment, the second transmission mechanism comprises a first belt pulley set and a first gear set moving with the first belt pulley set, the first gear set moves with the second power shaft, and the first belt pulley set moves with the second speed reducer. In still another embodiment, the second transmission mechanism further comprises a first transmission shaft and a second transmission shaft interlockedly rotating to two sides of the first belt pulley set, respectively, wherein the first transmission shaft moves with the first gear set, and the second transmission shaft actuates the second speed reducer. In an embodiment, the first belt pulley set comprises two rollers and a belt around the two rollers. In an embodiment, the transmission device further comprises a propping part propping against the belt.

In yet another embodiment, a transmission device according to the present disclosure comprises: a first housing having a first end portion and a second end portion opposing the first end portion; a second housing connected to the first end portion of the first housing; a third housing axially connected to the second housing; an adapter axially connected to the third housing; a first speed reducer disposed between the first end portion of the first housing and the second housing; a first power shaft for actuating the first speed reducer to drive the second housing to rotate with the third housing in the same direction; a second speed reducer disposed on the second housing; a second power shaft for actuating the second speed reducer through a second transmission mechanism to drive the third housing to rotate with respect to the second housing; a third speed reducer disposed on the third housing; and a third power shaft for actuating the third speed reducer through a third transmission mechanism to drive the adapter to rotate with respect to the third housing, wherein the third power shaft is a pipe, the first power shaft is positioned outside the pipe of the third power shaft, and the second power shaft passes through and is installed in the pipe of the third power shaft.

In an embodiment, the transmission device further comprises a first motor disposed on the second end portion of the first housing and drives the first power shaft. In another embodiment, the first motor drives the first power shaft through a bevel gear set.

In an embodiment, the first power shaft actuates the first speed reducer through a first transmission mechanism. In another embodiment, the first transmission mechanism is a gear set and transfers power of the first transmission mechanism through a connection structure to the first speed reducer, and the connection structure is a pipe. In another embodiment, the connection structure is a hollow pipe, and the second power shaft and the third power shaft pass through the connection structure.

In an embodiment, the transmission device further comprises a second motor for driving the second power shaft.

In an embodiment, the second transmission mechanism comprises a first belt pulley set and a first gear set moving with the first belt pulley set, wherein the first gear set moves with the second power shaft, and the first belt pulley set moves with the second speed reducer. In another embodiment, the first belt pulley set comprises two rollers and a belt around the two rollers, wherein the second transmission mechanism further comprises a first transmission shaft and a second transmission shaft interlockedly rotating to two sides of the first belt pulley set, respectively, and wherein the first transmission shaft moves with the first gear set, and the second transmission shaft actuates the second speed reducer. In yet another embodiment, the third transmission mechanism comprises a second belt pulley set, a third transmission shaft and a fourth transmission shaft interlockedly rotating to two sides of the second belt pulley set, wherein a second gear set and a third gear set move with the third transmission shaft and the fourth transmission shaft, respectively, the second gear set moves with the third power shaft, and the third gear set moves with the third speed reducer. In an embodiment, the first transmission shaft and the third transmission shaft are a coaxial structure, and the second transmission shaft and the fourth transmission shaft are another coaxial structure. In another embodiment, the transmission device further comprises a propping part propping against the belt.

In an embodiment, the transmission device further comprises a third motor for driving the third power shaft.

In an embodiment, the third transmission mechanism comprises a belt pulley set and two gear sets moving with the belt pulley set, and the two gear sets move with the third power shaft and the third speed reducer, respectively. In another embodiment, the third transmission mechanism further comprises two transmission shafts interlockedly rotating to two sides of the belt pulley set, respectively, to drive the two gear sets, respectively.

In an embodiment, a robotic arm according to the present disclosure comprises the above-described transmission devices, and an arm body pivotably connected to the second end portion of the first housing.

In an embodiment, the transmission device comprises a wrist portion.

Therefore, in a transmission device and a robotic arm according to the present disclosure, the first power shaft is installed outside the pipe of the third power shaft independently, and a first motor that is loaded with a smaller rotation inertia can be used. As compared with the prior art, the present disclosure can select the cheaper first motor and thus has a reduced cost.

### BRIEF DESCRIPTION OF DRAWINGS

The disclosure can be more fully understood by rearing the following detailed description of the embodiments, with reference made to the accompanying drawings, wherein:

FIG. 1A is a perspective view of a six-axis robot according to the prior art;

FIG. 1B is a cross-sectional view of a portion of a front arm of the robot of FIG. 1A;

FIG. 2A is a perspective view of a transmission device according to the present disclosure;

FIG. 2B is a schematic diagram of parts of a transmission device according to the present disclosure;

FIG. 3A is a perspective view of a portion of the transmission device of FIG. 2A;

FIG. 3B is a top view of FIG. 3A;

FIG. 4A is a perspective view of a second housing of FIG. 2A;

FIG. 4B is a planer view of a portion of FIG. 2A;

FIG. 5A is a perspective view of a third housing of FIG. 2A;

FIG. 5B is a planer view of a portion of FIG. 2A;

FIG. 5C is a planer view of a portion of FIG. 5B; and

FIG. 6 is a perspective view of a robotic arm according to the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

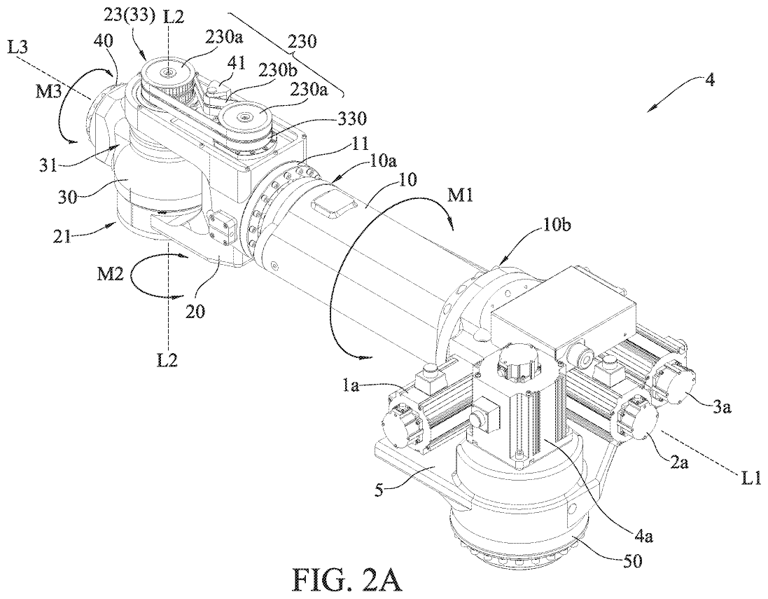

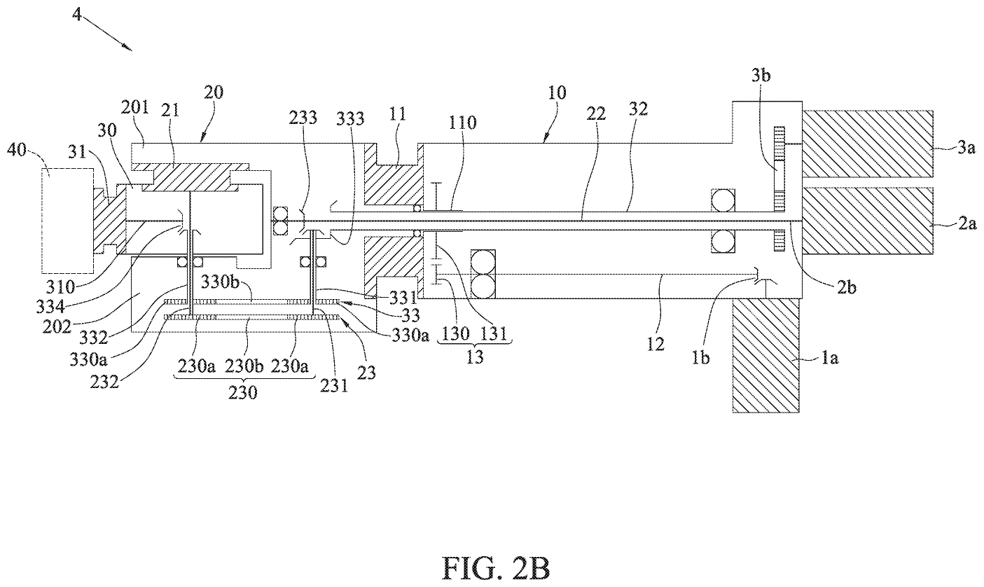

FIGS. 2A and 2B are schematic diagrams of a transmission device 4 according to the present disclosure. The transmission device 4 comprises a first housing 10, a first speed reducer 11, a first power shaft 12, a first transmission mechanism 13, a second housing 20 connected to the first housing 10, a second speed reducer 21, a second power shaft 22, a second transmission mechanism 23, a third housing 30 axially connected to the second housing 20, a third speed reducer 31, a third power shaft 32, and a third transmission mechanism 33.

In an embodiment, the transmission device 4 is installed with a first motor 1a, a second motor 2a and a third motor 3a as power sources for a first movement mode M1, a second movement mode M2 and a third movement mode M3, respectively.

In an embodiment, the first housing 10 is hollow or cylindrical, and has a first end portion 10a and a second end portion 10b opposing the first end portion 10a.

In an embodiment, the second end portion 10b of the first housing 10 can be installed with the first motor 1a, the second motor 2a and the third motor 3a, and is disposed with an externally connected structure 5 based on demands. In an embodiment, the externally connected structure 5 comprises an adapting axial part 50, and a fourth motor 4a can be mounted on the externally connected structure 5 to rotate the adapting axial part 50.

The first speed reducer 11 is connected to the first end portion 10a of the first housing 10. The power transmission of the first motor 1a uses the first speed reducer 11 to reduce speed.

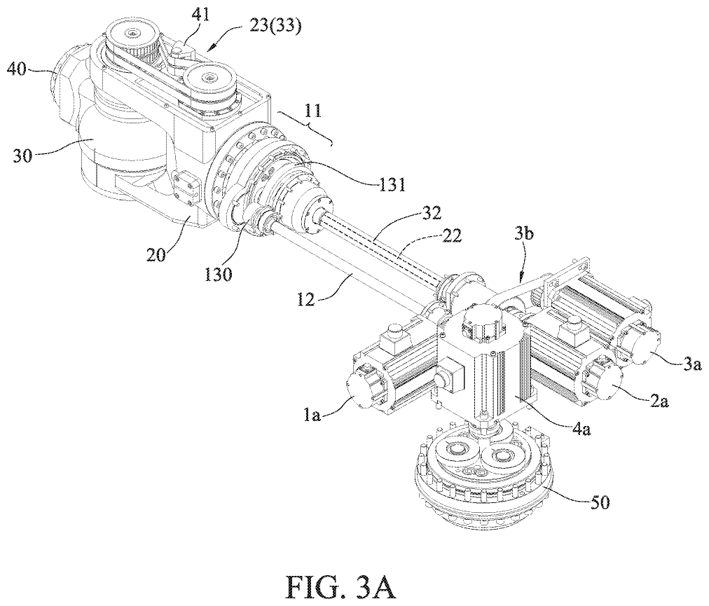

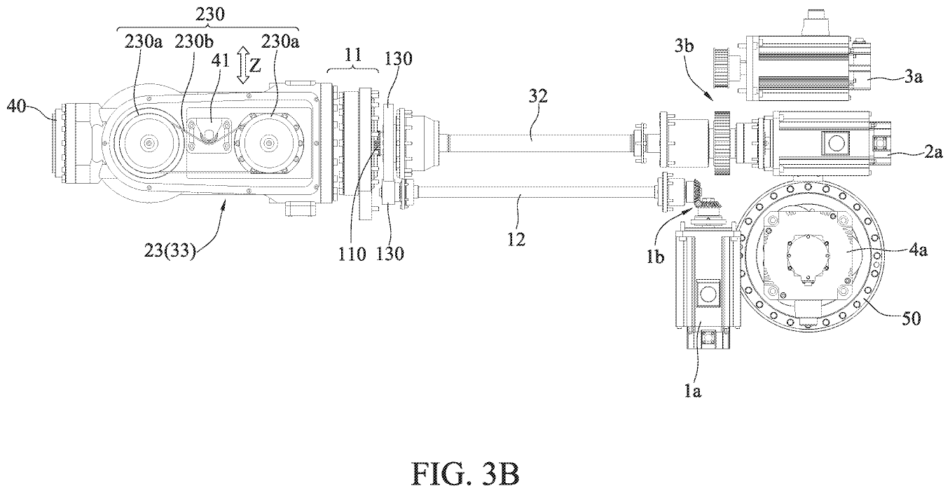

In an embodiment, the first speed reducer 11 has a speed-reduction ratio of 1/80, and a variety of structures, such as an offset-center swinging type shown in FIGS. 3A and 3B. The input power of the first speed reducer 11 transfers power of the first transmission mechanism 13 through a connection structure 110 to the first speed reducer 11.

The first power shaft 12 (as shown in FIG. 3A) is disposed in the first housing 10 and moves with the first motor 1a.

In an embodiment, the first motor 1a is connected through a bevel gear set 1b (as shown in FIG. 3B) to the first power shaft 12 and drives the first power shaft 12 to rotate.

The first transmission mechanism 13 is connected to the first power shaft 12 and the first speed reducer 11, and the first power shaft 12 actuates the first speed reducer 11 through the first transmission mechanism 13.

In an embodiment, the first transmission mechanism 13 comprises a gear set having two positive gears 130 and 131 (as shown in FIG. 3A). The first transmission mechanism 13 transfers its power through the two positive gears 130 and 131 to the connection structure 110. The connection structure 110 has its two opposing ends connected to the positive gear 131 of the first transmission mechanism 13 and a power inputting end of the first speed reducer 11, to output the power of the first transmission mechanism 13 to the first speed reducer 11. It is appreciated that the power of the first transmission mechanism 13 is transferred through the two positive gears 130 and 131 to the connection structure 110, and the two positive gears 130 and 131 can be replaced by a belt pulley or a chain.

The first speed reducer 11 is disposed between the first housing 10 and the second housing 20, and the second housing 20 does not move with respect to the first housing 10.

In an embodiment, the second housing 20 and the first housing 10 are axially disposed. In an embodiment, in the first movement mode M1 the first speed reducer 11 is axially interlockedly rotating to a side of the first end portion 10a of the first housing 10 and the second housing 20, the first power shaft 12 actuates the first speed reducer 11 through the first transmission mechanism 13, and the second housing 20 rotates with the third housing 30 in the same direction.

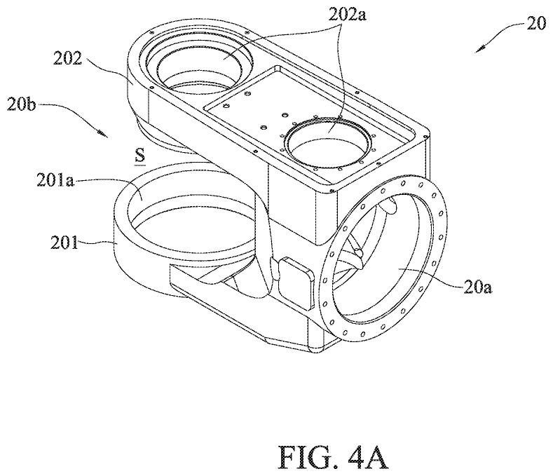

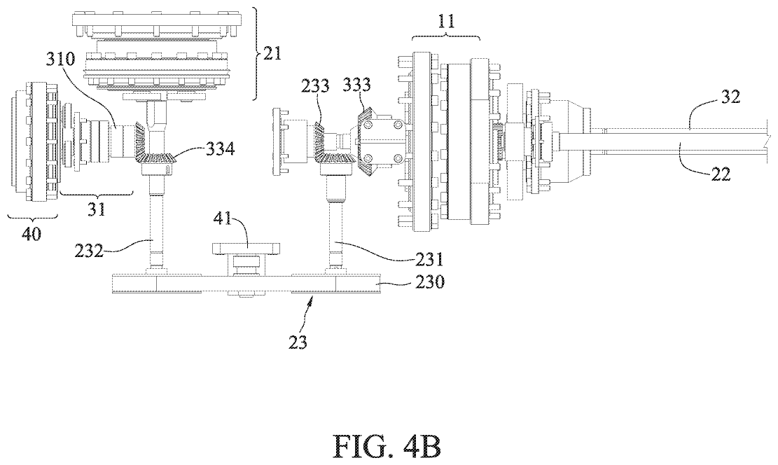

As shown in FIG. 4A, the second housing 20 is in the shape of an open rectangle, such as a fork, a hoof or a recess. In an embodiment, the second housing 20 has a rear end portion 20a that can be formed to be a round sleeve axially interlockedly rotating to the first speed reducer 11, and a front end portion 20b extending from the rear end portion 20a and formed with supporting parts 201 and 202 disposed on two sides thereof, respectively. A receiving space S is formed between the supporting parts 201 and 202. In an embodiment, the supporting part 201 has at least one groove 201a, and the supporting part 202 has at least one placement groove 202a.

The second speed reducer 21 is connected to the supporting part 201 of the second housing 20, and the power transmission of the second motor 2a uses the second speed reducer 21 to reduce speed.

In an embodiment, the second speed reducer 21 has a variety of structures, such as the gear set and the corresponding arrangement shown in FIG. 4B, and can be positioned in the groove 201a.

The second power shaft 22 is disposed in the first housing 10 and the second housing 20 and moves with the second motor 2a.

In an embodiment, an output shaft 2b of the second motor 2a is connected to the second power shaft 22 directly, and the second motor 2a drives the second power shaft 22 to rotate. In an embodiment, the output shaft 2b of the second motor 2a inputs power through a coupler (not shown) to the second power shaft 22.

The second transmission mechanism 23 is disposed in the second housing 20 and connected to the second power shaft 22 and the second speed reducer 21, and the second power shaft 22 actuates the second speed reducer 21 through the second transmission mechanism 23.

In an embodiment, the second transmission mechanism 23 comprises a first belt pulley set 230 (such as an external belt pulley set shown in FIGS. 2A and 2B), a first transmission shaft 231 and a second transmission shaft 232 interlockedly rotating to two sides of the first belt pulley set 230, respectively, and a first gear set 233 moving with the first transmission shaft 231, the first gear set 233 moves with the second power shaft 22, and the second transmission shaft 232 moves with the second speed reducer 21. In an embodiment, the first gear set 233 is a bevel gear set, and the second transmission shaft 232 and the second speed reducer 21 are disposed axially. The first belt pulley set 230 comprises two rollers 230a axially connected to the first transmission shaft 213 and the second transmission shaft 232, respectively, and a belt 230b around the two rollers 230a in a single-cycle manner. The belt 230b around the two rollers 230a in a single-cycle manner can prop against the belt 230 through a propping part 41, such as an idle pulley, to adjust the tension of the belt 230.

The first gear set 233 is disposed at the rear end portion 20a of the second housing 20, the other components of the second transmission mechanism 23 (e.g., the first belt pulley set 230, the first transmission shaft 231 and the second transmission shaft 232) are disposed on the placement groove 202a of the supporting part 202, and the second speed reducer 21 and the second transmission mechanism 23 are substantially disposed on two opposing sides of the second housing 20, respectively, i.e., the two supporting parts 201 and 202 of the second housing 20.

The second transmission shaft 232 is mounted between the supporting parts 201 and 202 across the receiving space S.

The third housing 30 is disposed in the receiving space S of the second housing 20, and axially connected to the second housing 20 along a direction of a vertical line between the two supporting parts 201 and 202.

In an embodiment, the third housing 30 is rotatably mounted on the two supporting parts 201 and 202 and connected to the second speed reducer 21, and the second speed reducer 21 drives the third housing 30 to rotate with respect to the second housing 20, such as in the second movement mode M2.

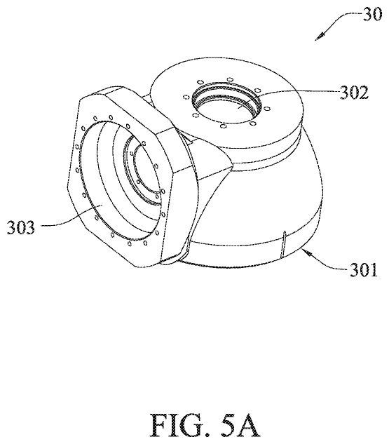

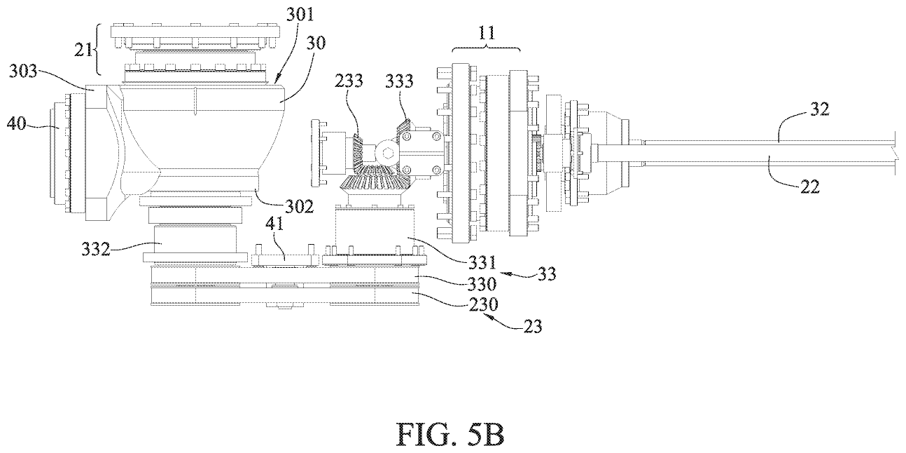

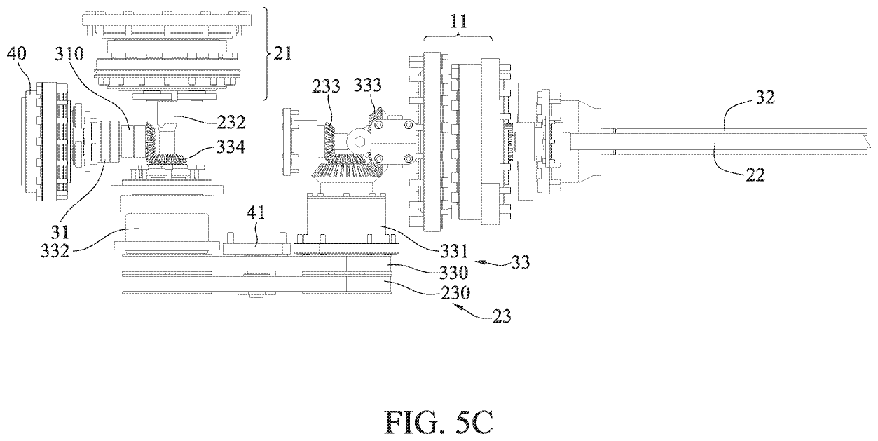

As shown in FIGS. 5A to 5C, the third housing 30 has a three-connected-pipe structure, and comprises a first pipe 301, a second pipe 302 and a third pipe 303, the second speed reducer 21 is interlockedly rotating to the first pipe 301, the second transmission shaft 232 passes through the second pipe 302 through the third housing 30 and is axially connected to the second speed reducer 21, and the third housing 30 rotates with respect to the second housing 20 with the second transmission shaft 232 as a rotation axis.

The third speed reducer 31 is connected to the third pipe 303 of the third housing 30, and the power transmission of the third motor 3a uses the third speed reducer 31 to reduce speed.

In an embodiment, the third speed reducer 31 has a variety of structures, such as a gear rod 310 and the corresponding arrangement shown in FIG. 5C.

The third power shaft 32 is disposed in the first housing 10 and the second housing 20. The third power shaft 32 is a pipe, the second power shaft 22 passes through and is installed in the pipe of the third power shaft 32, the second power shaft 22 and the third power shaft 32 are a two-layer coaxial structure, and the first power shaft 12 is disposed outside the pipe of the third power shaft 32.

In an embodiment, the third motor 3a is connected through a belt pulley set 3b (as shown in FIGS. 2B and 3A, the belt component omitted in FIG. 3B) to the third power shaft 32, and drives the third power shaft 32 to rotate. It can be appreciated that the third motor 3a can move with the third power shaft 32 through another transmission component, in addition to the belt pulley.

The connection structure 110 is a single pipe, and the second power shaft 22 and the third power shaft 32 pass through the connection structure 110, and pass through the first speed reducer 21 through a bearing component.

The third transmission mechanism 33 is disposed in the second housing 20 and the third housing 30 and connected to the third power shaft 32 and the third speed reducer 31, and the third power shaft 32 actuates the third speed reducer 31 through the third transmission mechanism 33.

In an embodiment, the third transmission mechanism 33 comprises a second belt pulley set 330 (such as the belt pulley set shown in FIGS. 2A and 2B), a third transmission shaft 331 and a fourth transmission shaft 332 interlockedly rotating to two sides of the second belt pulley set 330, respectively, and a second gear set 333 and a third gear set 334 moving with the third transmission shaft 331 and the fourth transmission shaft 332, respectively, the second gear set 333 moves with the third power shaft 32, and the third gear set 334 moves with the third speed reducer 31. In an embodiment, the second gear set 333 and the third gear set 334 are a bevel gear set, the second belt pulley set 330 comprises two rollers 330a axially connected to the third transmission shaft 331 and the fourth transmission shaft 332, respectively, and a belt 330b around the two rollers 330a in a single-cycle manner, and the propping part 41 props against the belt 330 to change the tension of the belt 330.

The second gear set 333 is disposed at the rear end portion 20a of the second housing 20, the other components of the third transmission mechanism 33 (e.g., the second belt pulley set 330, the third transmission shaft 331 and the fourth transmission shaft 332) are positioned on the placement groove 202a of the supporting parts 202, and some components of the second speed reducer 21 and the third transmission mechanism 33 are disposed at two opposing sides of the second housing 20, i.e., the two supporting parts 201 and 202 of the second housing 20.

The fourth transmission shaft 332 is mounted on the supporting parts 202, protrudes from the receiving space S of the second housing 20 and into the third housing 30, and the third gear set 334 is disposed in the third housing 30.

The first transmission shaft 231 and the third transmission shaft 331 have a coaxial structure. The second transmission shaft 232 and the fourth transmission shaft 332 have a coaxial structure. In an embodiment, the third transmission shaft 331 and the fourth transmission shaft 332 are a pipe, the first transmission shaft 231 passes through the third transmission shaft 331, and the second transmission shaft 232 passes through the fourth transmission shaft 332. When the first and second belt pulley sets 230 and 330 are installed in the identical supporting parts 202 of the second housing 20, the space where the second and third transmission mechanisms 23 and 33 are installed is reduced, and the second housing 20 can thus has a reduced volume accordingly.

The transmission device 4 further comprises an adapter 40 axially connected to the third housing 30. In an embodiment, the adapter 40 is connected to the third speed reducer 31, and the third speed reducer 31 drives the adapter 40 to rotate with respect to the third housing 30, such as in the third movement mode M3.

The transmission device 4 operates as follows.

In the first movement mode M1, the first motor 1a transfers power through the bevel gear set 1b to drive the first power shaft 12, the first power shaft 12 transfers the power through the first transmission mechanism 13 and actuates the first speed reducer 11, the first speed reducer 11 drives the first housing 10 and the second housing 20, and the third housing 30 as well, to auto-rotate in the same direction along a first axis line L1 (as shown in FIG. 2A, or along the second power shaft 22 or the third power shaft 32) (i.e., the first to third housings 10, 20 and 30 rotating with respect to the externally connected structure 5), and the first to third housing 10, 20 and 30, when moving, can have their speeds reduced.

In the second movement mode M2, the second motor 2a transfers power through the output shaft 2b and drives the second power shaft 22, the second power shaft 22 transfers power through the second transmission mechanism 23 (the power transmission is in the order from the first gear set 233, the first transmission shaft 231, the first belt pulley set 230, to the second transmission shaft 232, as shown in FIG. 4B) and actuates the second speed reducer 21, the second speed reducer 21 drives the third housing 30 to rotate with respect to the second housing 20 along a second axis line L2 (as shown in FIG. 2A, or along the second transmission shaft 232), and the third housing 30, when moving, can have its speed reduced.

In the third movement mode M3, the third motor 3a transfers power through the belt pulley set 3b and drives the third power shaft 32, the third power shaft 32 transfers power through the third transmission mechanism 33 (the power transmission is in the order from the second gear set 333, the third transmission shaft 331, the second belt pulley set 330, the fourth transmission shaft 332 to the third gear set 334) and actuates the third speed reducer 31, the third speed reducer 31 drives the adapter 40 to rotate with respect to the third housing 30 along a third axis line L3 (as shown in FIG. 2A, or along the gear rod 310), and the adapter 40, when moving, has its speed reduced.

In an embodiment, the second axis line L2 intersects the first axis line L1 at a predefine angle (e.g., in a vertical state), and the third axis line L3 intersects the second axis line L2 at a predefined angle (e.g., in a vertical state).

The first axis line L1 and the third axis line L3 can be on the same straight path, or on different straight paths.

In another embodiment, if the second axis line L2 does not pass through an extending line of the first axis line L1 and is not parallel to the first axis line L1, the second axis line L2 cannot intersect the first axis line L1. If the third axis line L3 does not pass through an extending line of the second axis line L2 and is not parallel to the second axis line L2, the third axis line L3 cannot intersect the second axis line L2.

The tension of the belts 230b and 330b of the first and second belt pulley sets 230 and 330 can be adjusted by moving (toward an arrow direction Z shown in FIG. 3B) the propping part 41 (e.g., idle pulley) and fixing the propping part 41 by a screw. The first and second belt pulley sets 230 and 330 or the belts 230b and 330b can be replaced when the propping part 41 is not fixed (e.g., by loosening the screw).

According to the transmission device 4 of the present disclosure, in which the second power shaft 22 and the third power shaft 32 have a coaxial structure, the first power shaft 12 is disposed outside the pipe of the third power shaft 32 independently, and the first motor 1a can be loaded with a small rotation inertia. As compared with the prior art, the present disclosure can select the first motor 1a that is cheaper, and thus has its cost reduced. The rotation inertia of the first power shaft 12 can be considered as the rotation inertia of the motor transmission shafts, and can be obtained based on the following equation (1):

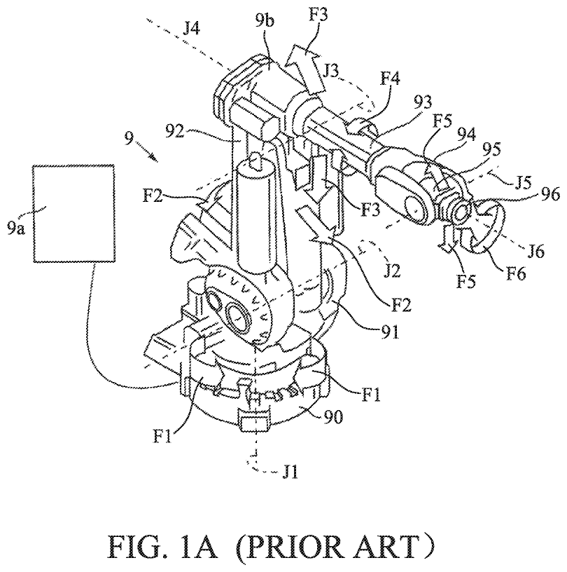

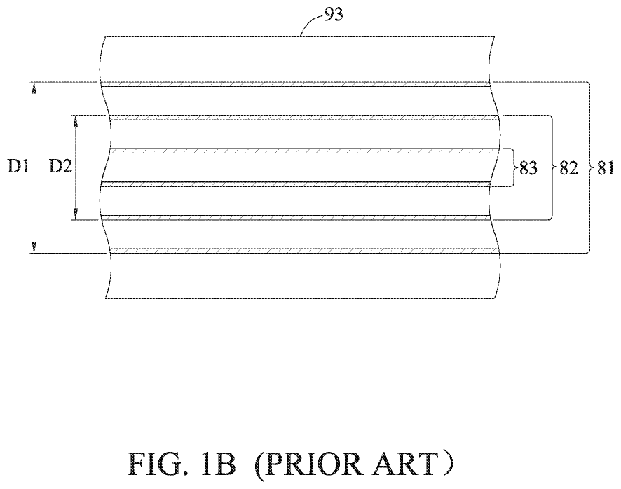

I=½mr² (1)

where m represents the mass (kg) of a power rod, and r represents the radius (mm) of the power rod. Therefore, the rotation inertia of the first power shaft 12 is 0.5·2.11²=121 (kg-mm²), and the rotation inertia of the outer axial rod according to the prior art (as shown in FIG. 1B, in which the outer radius D1 of the first transmission rod 81 is 52 mm, and the outer radius D2 of the second transmission rod 82 is 38 mm) is 0.5·3(19²+26²)=1555 (kg-mm²), which is over 10 times as large as 121 (kg-mm²). Hence, the first motor 1a of the present disclosure is loaded with a much smaller rotation inertia than the rotation inertia of the prior art.

According to the present disclosure, since the first speed reducer 11 is disposed between the first end portion 10a of the first housing 10 and the second housing 20, a distance between the adapter 40 and the first speed reducer 11 is greatly reduced, and an endurable bending moment can be achieved. Therefore, the transmission device 4 according to the present disclosure can select the first speed reducer 11 that is cheaper to reduce the manufacturing cost, or the adapter 40 of the transmission device 4 can hold a heavier object. The bending moment M is obtained by the following equation (2):

M=FL (2)

where F represents the weight that the adapter 40 is going to hold, and L represent a length (i.e., the distance between the adapter 40 and the first speed reducer 11). As the length L of the transmission device 4 is 550 mm and the length L of the six-axis robot 9 according to the prior art is 1200 mm (i.e., a distance between the motor 9b and the rotating disk 96 shown in FIG. 1A), under the condition of same motor power (i.e., the same bending moment M), the transmission device 4 according to the present disclosure can hold an object of 150 kg, while the robotic arm according to the prior art can hold an object of less than 70 kg. In other words, under the same weight F (i.e., the same object), the bending moment of the first speed reducer 11 according to the present disclosure is smaller than the bending moment of the speed-reducer according to the prior art. Since the larger the speed-reducer allows the bending moment to become, the higher the cost of the speed-reducer is, the first speed reducer 11 according to the present disclosure is cheaper than the speed-reducer according to the prior art.

Since the second transmission mechanism 23 and the third transmission mechanism 33 are disposed in the same supporting part 202 of the second housing 20 and the second speed reducer 21 is disposed in the another supporting part 201 of the first housing 20, the two supporting parts 201 and 202 of the second housing 20 and structures therein have predefined weight. Therefore, the third housing 30 and components disposed thereon can be supported by a solid force, and the two supporting parts 201 and 202 can be prevented from being broken. On the contrary, if one of the second transmission mechanism 23 and the third transmission mechanism 33 is disposed in the another supporting part 201, the inner weight of the supporting part 202 is reduced. Therefore, the second housing 20 will suffer an unstable gravity and is likely inclined, the third housing 30 and the components disposed thereon cannot be supported by a solid force, and the supporting part 201 is likely to be broken.

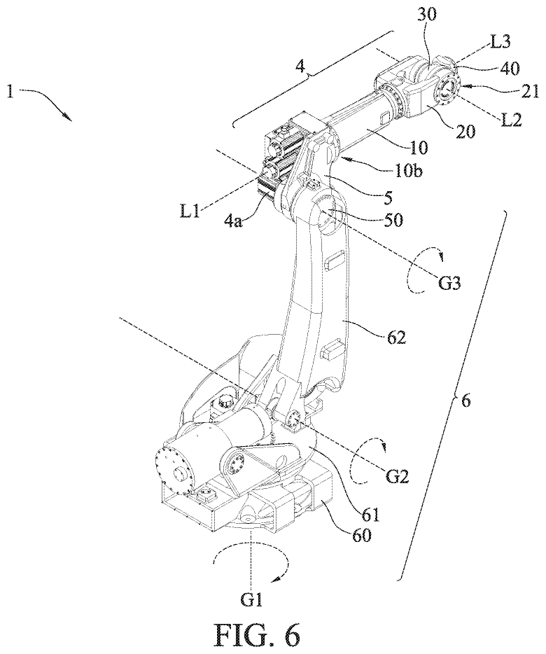

As shown in FIG. 6, the second end portion 10b of the first housing 10 of the transmission device 4 according to the present disclosure can be pivotably connected to an arm body 6, to form a robotic arm 1. In an embodiment, the arm body 6 comprises a base 60, a first arm portion 61 disposed on the base 60, a second arm portion 62 connected to the first arm portion 61, and the externally connected structure 5. The transmission device 4 is connected through an adapting axial part 50 of the externally connected structure 5 to the second arm portion 62. The second housing 20 and the third housing 30 of the transmission device 4 can be considered collectively as a wrist portion. In an embodiment, the first arm portion 61 performs a first axial rotation mode G1 with respect to the base 60 following a dashed axis line shown in FIG. 6. A bottom end of second arm portion 62 is rotatably pivotably connected to the first arm portion 61, and the second arm portion 62 performs a second axial rotation mode G2 following a dashed axis line shown in FIG. 6. The transmission device 4 can be axially connected through the externally connected structure 5 to a top end of the second arm portion 62, and perform a third axial rotation mode G3 following a dashed axis line of the adapting axial part 50 shown in FIG. 6. It can be appreciated that the first movement mode M1 acts as a fourth axial rotation, the second movement mode M2 acts as a fifth axis rotation, and the third movement mode M3 acts as a sixth axial rotation.

In sum, in the robotic arm 1 and the transmission device 4 according to the present disclosure the second end portion 10b of the first housing 10 is disposed with three motors (first to third motor 1a, 2a and 3a), to reduce the possibility that the wires are damaged, reduce the load of the first motor 1a, and improve the transmission efficiency of the first motor 1a.

According to the present disclosure, the second and third housings 20 and 30 do not need any motor to be disposed thereon, and thus have compact inner structures (e.g., the first transmission shaft 231 and the third transmission shaft 331 constitute a coaxial structure, and the second transmission shaft 232 and the fourth transmission shaft 332 constitute another coaxial structure) and reduced volume.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A transmission device, comprising:
a first housing having a first end portion and a second end portion opposing each other;
a second housing connected to the first end portion of the first housing;
a first speed reducer disposed between the first end portion of the first housing and the second housing; and
a first power shaft for actuating the first speed reducer to drive the second housing to rotate.

2. The transmission device of claim 1, wherein the first power shaft actuates the first speed reducer through a first transmission mechanism.

3. The transmission device of claim 2, further comprising a first motor for driving the first power shaft.

4. The transmission device of claim 3, wherein the first motor drives the first power shaft through a bevel gear set.

5. The transmission device of claim 2, wherein the first transmission mechanism is a gear set and transfers power of the first transmission mechanism through a connection structure to the first speed reducer, and wherein the connection structure is a pipe.

6. The transmission device of claim 2, further comprising:
a third housing axially connected to the second housing, wherein the first power shaft actuates the first speed reducer through the first transmission mechanism to drive the second housing and the third housing to rotate in the same direction;
a second speed reducer disposed on the second housing; and
a second power shaft for actuating the second speed reducer through a second transmission mechanism to drive the third housing to rotate with respect to the second housing.

7. The transmission device of claim 6, further comprising a first motor disposed on the second end portion of the first housing for driving the first power shaft.

8. The transmission device of claim 6, further comprising a second motor for driving the second power shaft.

9. The transmission device of claim 6, wherein the second transmission mechanism comprises a first belt pulley set and a first gear set moving with the first belt pulley set for the second power shaft to be moved with the first gear set and the first belt pulley set to be moved with the second speed reducer.

10. The transmission device of claim 9, wherein the second transmission mechanism further comprises a first transmission shaft and a second transmission shaft interlockedly rotating to two sides of the first belt pulley set, respectively, and wherein the first transmission shaft moves with the first gear set, and the second transmission shaft actuates the second speed reducer.

11. The transmission device of claim 9, wherein the first belt pulley set comprises two rollers and a belt around the two rollers.

12. The transmission device of claim 11, further comprising a propping part propping against the belt.

13. The transmission device of claim 6, further comprising:
an adapter axially connected to the third housing;
a third speed reducer disposed on the third housing; and
a third power shaft for actuating the third speed reducer through a third transmission mechanism to drive the adapter to rotate with respect to the third housing, wherein the third power shaft is a pipe, the first power shaft is positioned outside the pipe of the third power shaft, and the second power shaft passes through and is installed in the pipe of the third power shaft.

14. The transmission device of claim 13, wherein the first transmission mechanism is a gear set and transfers power of the first transmission mechanism through a connection structure to the first speed reducer, and wherein the connection structure is a pipe.

15. The transmission device of claim 14, wherein the connection structure is a hollow pipe, and the second power shaft and the third power shaft pass through the connection structure.

16. The transmission device of claim 13, wherein the second transmission mechanism further comprises a first transmission shaft and a second transmission shaft interlockedly rotating to two sides of the first belt pulley set, respectively, and wherein the first transmission shaft moves with the first gear set, and the second transmission shaft actuates the second speed reducer.

17. The transmission device of claim 16, wherein the third transmission mechanism further comprises a second belt pulley set, a third transmission shaft and a fourth transmission shaft interlockedly rotating to two sides of the second belt pulley set, respectively, and a second gear set and a third gear set moving with the third transmission shaft and the fourth transmission shaft, respectively, wherein the third power shaft moves with the second gear set, and the third speed reducer moves with the third gear set.

18. The transmission device of claim 17, wherein the first transmission shaft and the third transmission shaft are a coaxial structure, and the second transmission shaft and the fourth transmission shaft are another coaxial structure.

19. The transmission device of claim 13, further comprising a third motor for driving the third power shaft.

20. The transmission device of claim 13, wherein the third transmission mechanism further comprises a belt pulley set and two gear sets moving with the belt pulley set, and wherein the gear sets move with the third power shaft and the third speed reducer, respectively.

21. The transmission device of claim 20, wherein the third transmission mechanism further comprises two transmission shafts interlockedly rotating to two sides of the belt pulley set for driving the gear sets, respectively.

22. A robotic arm, comprising:
the transmission device of claim 1; and
an arm body pivotably connected to the second end portion of the first housing.

23. The robotic arm of claim 22, wherein the transmission device comprises a wrist portion.
